(19) United States
(12) Patent Application Publication
(10) Pub. No.: US 2022/0304495 A1
(43) Pub. Date: Sep. 29, 2022

(54) MULTIFUNCTIONAL COOKER

(71) Applicant: GUANGDONG SHUNDE OUNING TECHNOLOGY ELECTRICAL APPLIANCE CO., LTD., Guangdong (CN)

(72) Inventor: Zhenxiong HUANG, Guangdong (CN)

(73) Assignee: GUANGDONG SHUNDE OUNING TECHNOLOGY ELECTRICAL APPLIANCE CO., LTD., Guangdong (CN)

(21) Appl. No.: 17/439,824

(22) PCT Filed: Nov. 11, 2020
(86) PCT No.: PCT/CN2020/127996

§ 371 Date: Sep. 16, 2021

(30) Foreign Application Priority Data
Oct. 29, 2020 (CN) 202011181472.3

(51) Int. Cl. A47J 27/086; A47J 37/06; A47J 27/00

(52) U.S. Cl. CPC A47J 27/086; A47J 37/0641; A47J 27/002

(57) ABSTRACT

A multifunctional cooker includes a pressure cooker body and an upper cover assembly covered on the cooker body. The upper cover assembly is provided with a heating assembly, a wind power assembly, and an inner top cover that controls whether the upper cover assembly is sealedly covered on the cooker body. The wind power assembly is provided with a main fan for blowing hot air heated by the heating assembly into the cooker body to cook, and the main fan is provided above the inner top cover and above the heating assembly.

### BACKGROUND

### Technical Field

The present invention relates to a kitchenware, and in particular, relates to a multifunctional cooker.

### Description of Related Art

Existing consumers are constantly pursuing healthy cooking and a diet full of color, aroma and taste. Pressure cooking increases the cooking temperature by increasing the pressure in the cooker, thereby shortening the cooking time of the food and keeping the nutrients to a greater extent. However, after pressure cooking, the surface color and taste of the food may not reach the ideal crispy and delicious state of some consumers. If it can also be secondary cooked using the fast baking function of the air dryer, the food will be healthy and nutritious, and will be full of color, aroma and taste as well. Such food would be popular with consumers and would have huge market potential. The existing pressure cooker only has the function of pressure cooking. Similarly, the air fryer only has the function of cooking food by hot air. At present, there are few products which have cooking functions of both pressure cooker and air fryer. These products are ether using an air fryer as the main body, and equipped with a pressure cooker head cover for using additionally, such as a dual-purpose cooker combining an air fryer and a pressure cooker disclosed in Chinese Patent Publication No. CN209826275U. Or these products are using two replaceable accessories mounted on cooker cover to realize the functions of the pressure cooker and the air fryer respectively, such as an air fryer head mounted on an electric pressure cooker disclosed in Chinese Patent Publication No. CN210961465U. The above two ways inevitably increase the material cost, packaging cost and increase the complexity of the operation.

In addition, because there is a gap between the inner top cover and the motor shaft sleeve of the wind assembly of the air fryer, there is a sealing problem in the integration of pressure cooking and air fryer functions. When the pressure cooking function is used, cooking effects will be affected by sealing problems.

### SUMMARY

To overcome the above existing defects, the present invention provides a multifunctional cooker.

In the present technical solution, a multifunctional cooker is provided, which comprises a pressure cooker body and an upper cover assembly covered on the pressure cooker body. The upper cover assembly is provided with a heating assembly, a wind power assembly, and an inner top cover that controls whether the upper cover assembly is sealedly covered on the pressure cooker body. The wind power assembly is provided with a main fan for blowing hot air heated by the heating assembly into the pressure cooker body to cook, and the main fan is provided above the inner top cover and above the heating assembly.

Via the configuration that the multifunctional cooker comprises the pressure cooker body and the upper cover assembly covered on the pressure cooker body, and that the upper cover assembly is provided with the heating assembly, the wind power assembly, and the inner top cover that controls whether the upper cover assembly is sealedly covered on the pressure cooker body, the present invention utilizes the pressure cooker body and the upper cover assembly covered on the pressure cooker body to form the pressure cooking mode. Combining the pressure cooking mode with the air fryer mode of the heating assembly and the wind power assembly, the function of inner top cover is utilized to switch the sealing performance inside of the multifunctional cooker, thereby realizing the mutual switch between pressure cooking and air fryer functions, and realizing one cooker with multiple functions, which simplifies the structure, avoids double covers, and reduces costs. In addition, the configuration that the main fan is provided above the inner top cover and above the heating assembly avoids the main fan from being located below the inner top cover, and avoids the integral sealing of the inner top cover from being affected due to a gap between a motor shaft sleeve and the inner top cover when in the pressure cooking mode, thereby avoiding the sealing performance of the upper cover assembly covered on the pressure cooker body from being affected, and avoiding the pressure cooking effect from being affected.

Preferably, the inner top cover is provided with a first air inlet for air blown from the main fan to flow in and a first air outlet for the hot air to flow out. The purpose of this configuration is to form hot air communication via the configuration of the first air inlet and the first air outlet of the main fan in the air fryer mode, so as to effectively perform the cooking of the air fryer.

Preferably, the first air inlet is located at a top portion of the inner top cover, and the first air outlet is located on a side surface of the inner top cover, or the first air inlet is located at a central position of the top portion or the side surface of the inner top cover, and the first air outlet is located at a peripheral position of the top portion or the side surface of the inner top cover. It should be noted that the configuration of the positions of the first air inlet and the first air outlet are only preferred and are not a restrictive provision, and the configuration of other positions is also feasible.

Preferably, the wind power assembly further comprises a motor for providing power and a cooling fan for sucking outside cold air for air ventilation so as to cool down components in the upper cover assembly. The cooling fan and the main fan are sequentially connected to both ends of a sleeve of an output shaft of the motor. With such configuration, when in the air fryer cooking mode, the outside cold air can be sucked in by the cooling fan to lower the temperature of the surfaces of the motor and the inner top cover, avoiding the burning of the motor and damaging the inner top cover due to excessive temperature, and improving service life of the upper cover assembly. It should be noted that the heating assembly are generally provided below the inner top cover, and the heating assembly are preferably heating wires. Of course, these configurations are only preferred and not a restrictive provision.

The present invention further provides a multifunctional cooker, which includes a pressure cooker body and an upper cover assembly covered on the pressure cooker body, wherein the upper cover assembly is provided with a heating assembly, a wind power assembly, and an inner top cover that controls whether the upper cover assembly is sealedly covered on the pressure cooker body, the wind power assembly is provided with a main fan for blowing hot air heated by the heating assembly into the pressure cooker body to cook, and the main fan is provided below the inner top cover and above the wind power assembly.

Via the configuration that the multifunctional cooker comprises the pressure cooker body of the pressure cooker and the upper cover assembly covered on the pressure cooker body, and that the upper cover assembly is provided with the heating assembly, the wind power assembly, and the inner top cover that controls whether the upper cover assembly is sealedly covered on the pressure cooker body, the present invention utilizes the pressure cooker body and the upper cover assembly covered on the pressure cooker body to form the pressure cooking mode. Combining the pressure cooking mode with the air fryer mode of the heating assembly and the wind power assembly, the function of the inner top cover is utilized to switch the sealing performance inside of the multifunctional cooker, thereby realizing the mutual switch between pressure cooking and air fryer functions, and realizing one cooker with multiple functions, which simplifies the structure, avoids double covers, and reduces costs. At the same time, the configuration that the main fan is provided below the inner top cover and above the heating assembly avoids the main fan from being located below the inner top cover is convenient for the main fan to blow the hot air heated by the heating assembly into the pressure cooker body at a short distance and to promote the circulation of the hot air, thereby baking and cooking food effectively.

Preferably, the inner top cover is provided with a first opening for communicating with outside air and a control member for controlling whether the first opening is closed. The configuration of the first opening is, in the air fryer cooking mode, to facilitate the communication of air, and also facilitate the water vapor which is generated after the food is heated to be discharged through the first opening, which is beneficial to produce a crisp effect on the food surface and improve the cooking effect. The configuration of the control member is to adapt to the two cooking modes by closing or opening the first opening. When in the pressure cooking mode, the first opening is closed. When in the air fryer mode (i.e., the baking and cooking mode), the first opening is opened.

Preferably, the control member comprises a movable valve assembly for closing the first opening and a drive assembly for driving the movable valve assembly to move so as to cover or open the first opening. The movable valve assembly is located at a position of the first opening at an inner side of the inner top cover. The drive assembly passes through the first opening and is connected with the movable valve assembly. Such configuration is to promote the movement of the movable valve assembly through the action of the drive assembly, thereby completing the closing or opening of the first opening, and realizing the closed or non-closed states of the upper cover assembly with a space of the pressure cooker body to adapt to the needs of the pressure cooking mode (i.e., the pressure cooker mode) and the baking and cooking mode (i.e., the air fryer mode). Via the configuration that the movable valve assembly is located at the position of the first opening at the inner side of the inner top cover and that the drive assembly passes through the first opening and is connected with the movable valve assembly, the first opening may be opened by pushing the movable valve assembly forward and the movable valve assembly is covered at the position of the first opening to close first opening by pulling the movable valve assembly backward. Of course, it should be noted that this way of opening or closing the first opening is only preferred and is not a restrictive provision. Other similar structural designs are feasible as long as this effect can be realized.

Preferably, the movable valve assembly comprises a valve body and a valve sealing ring, and the valve sealing ring is sleeved on the valve body. The drive assembly comprises a drive rod and a pull nail, and the drive rod and the pull nail movably pass through the first opening and are both connected with the valve body. Such configuration is to provide a movable valve assembly for closing the first opening and a drive assembly for driving the movable valve assembly. It should be noted that this structure is only preferred and not a restrictive provision. The common configuration of the drive rod and the pull nail is to provide a balanced pulling force, so as to better realize the corresponding movement and avoid tilting.

Preferably, the upper cover assembly is further provided with an inner buckle cover, and the inner buckle cover is rotatably sleeved on an outer side of the inner top cover. The inner buckle cover is provided with a baffle for pushing the drive rod to move so as to open the first opening, and a top portion of the drive rod is an inclined portion. Return springs are provided between the drive rod and the position of the first opening, and are provided between the pull nail and the position of the first opening. The return springs are configured for pulling the drive rod and the pull nail to return so as to close the first opening. The configuration that the upper cover assembly is further provided with an inner buckle cover rotatably sleeved on the outer side of the inner top cover, and that the inner buckle cover is provided with a baffle for pushing the drive rod to move so as to open the first opening, and that the top portion of the drive rod is the inclined portion, provides a way to realize the relative position change of the inner buckle cover and the inner top cover by rotating the inner buckle cover. When the baffle touches the top portion of the drive rod, the baffle will push the drive rod to move, so as to push the movable valve assembly, i.e., the valve body and the valve sealing ring as a whole, to move, thereby opening the first opening. When no force is applied by the baffle, the return spring will provide restoring force, such that the drive rod and the pull nail move back together, thereby pulling the movable valve assembly to move and cover at a position of the first opening, thereby closing the first opening structure.

Preferably, an isolation hood and a cooker cover sealing ring assembly are provided below the inner top cover. The configuration of the isolation hood may prevent the pressure in the pressure cooker body from being directly applied to the motor in the pressure cooking mode, which reduces the bearing pressure problem of the motor shaft and increases the service life of the motor, and thus increases the service life of the upper cover assembly as a whole. At the same time, due to the configuration of the isolation hood, the problem of the gap between the motor shaft sleeve and the inner top cover may also be solved, thereby improving the sealing performance. Of course, such configuration mainly solves problem that the gap between the bearing and the bearing sleeve affects the pressure cooking of the multifunctional cooker when the main fan is located below the inner top cover. At the same time, it may also reduce the food pollution of the motor and other components during cooking, and may also improve the convenience of cleaning. Preferably, the isolation hood is generally provided below the main fan and the heating assembly. Of course, the isolation hood may also be provided between the main fan and the heating assembly, and corresponding channels need to be provided in these different positions to facilitate the communication of hot air. In general, the isolation hood and the cooker cover sealing ring assembly are configured to be detachable structures. Fixed structures may also be selected, which may be selected according to specific conditions. In addition, the configuration of the cooker cover sealing ring assembly functions to seal inner pot in the pressure cooker body and the inner top cover. It is generally provided at the position below the inner top cover where the inner top cover is covered and engaged with the inner pot of the pressure cooker body.

Compared with the prior art, the present invention has the following the beneficial effects.

Via the configuration that the multifunctional cooker includes a pressure cooker body and the upper cover assembly covered on the pressure cooker body, and that the upper cover assembly is provided with the heating assembly, the wind power assembly, and the inner top cover that controls whether the upper cover assembly is sealedly covered on the pressure cooker body, the present invention utilizes the pressure cooker body and the upper cover assembly covered on the pressure cooker body to form the pressure cooking mode. Combining the pressure cooking mode with the air fryer mode of the heating assembly and the wind power assembly, the function of inner top cover is utilized to switch the sealing performance inside of the multifunctional cooker, thereby realizing the mutual switch between pressure cooking and air fryer functions, and realizing one cooker with multiple functions, which simplifies the structure, avoids double covers, and reduces costs. In addition, the configuration that the main fan is provided above the inner top cover and above the heating assembly avoids the main fan from being located below the inner top cover, and avoids the integral sealing of the inner top cover from being affected due to a gap between a motor shaft sleeve and the inner top cover when in the pressure cooking mode, thereby avoiding the sealing performance of the upper cover assembly covered on the pressure cooker body from being affected, and avoiding the pressure cooking effect from being affected. The present invention further provides a multifunctional cooker. Via the configuration that the main fan is provided below the inner top cover and above the heating assembly, which is convenient for the main fan to blow the hot air heated by the heating assembly into the pressure cooker body at a short distance and promotes the circulation of the hot air, the multifunctional cooker bakes and cooks food effectively.

### BRIEF DESCRIPTION OF THE DRAWINGS

FIG. 1 is a schematic structural view of a multifunctional cooker of the present invention.

FIG. 2 is an exploded view of the multifunctional cooker of the present invention.

FIG. 3 is a schematic structural view of an upper cover assembly before a control member is mounted.

FIG. 4 is a schematic structural view of a cooker cover sealing ring assembly.

FIG. 5 is a schematic structural view of a float valve assembly of the multifunctional cooker in a zero-pressure state.

FIG. 6 is a schematic structural view of the float valve assembly of the multifunctional cooker in a rising pressure state.

FIG. 7 is a partial schematic structural view of the upper cover assembly.

FIG. 8 is a schematic structural view which shows the cooperation between an inner buckle cover and an inner top cover in an opened state (air fryer cooking state) of the multifunctional cooker.

FIG. 9 is a schematic structural view which shows the cooperation between the inner buckle cover and the inner top cover in a closed state (pressure cooking state) of the multifunctional cooker.

FIG. 10 is a schematic structural view I of the upper cover assembly in the closed state (pressure cooking state) of the multifunctional cooker.

FIG. 11 is a schematic structural view II of the upper cover assembly in the closed state (pressure cooking state) of the multifunctional cooker.

FIG. 12 is a schematic structural view I of the upper cover assembly in the opened state (air fryer cooking state) of the multifunctional cooker.

FIG. 13 is a schematic structural view II of the upper cover assembly in the opened state (air fryer cooking state) of the multifunctional cooker.

### DESCRIPTION OF THE EMBODIMENTS

The accompanying drawings are only for exemplary description, and shall not be construed as limiting the present invention. For ease of description for the embodiments, some parts or elements in the accompanying drawings may be omitted, scaled up or scaled down, which do not represent the practical dimensions of the product. For a person skilled in the art, it is understandable that some commonly known structures may be omitted in accompanying drawings and that their descriptions may be omitted. The positional relationship described in the accompanying drawings is for illustrative purposes only, and cannot be understood as limiting to the present invention.

The same or similar reference numerals in the drawings of the embodiments of the present invention correspond to the same or similar components. In the description of the present invention, it should be understood that if there are the terms “upper”, “lower”, “left”, “right”, “long”, “short” and other terms which indicate the orientation or positional relationship or whose orientation or positional relationship is based on the orientation or positional relationship that shown in the drawings, and is only for the convenience of describing the present invention and simplifying the description, rather than indicating or implying that the device or element referred to must have a specific orientation and must be constructed and operated in a specific position. So the terms describing the positional relationship in the drawings are only used for exemplary description, and cannot be understood as a limitation of the present patent. For those of ordinary skill in the art, the specific meaning of the above terms can be understood according to the specific situation.

The technical solutions of the present invention will be further described in detail through specific embodiments in conjunction with the accompanying drawings.

### Embodiment 1

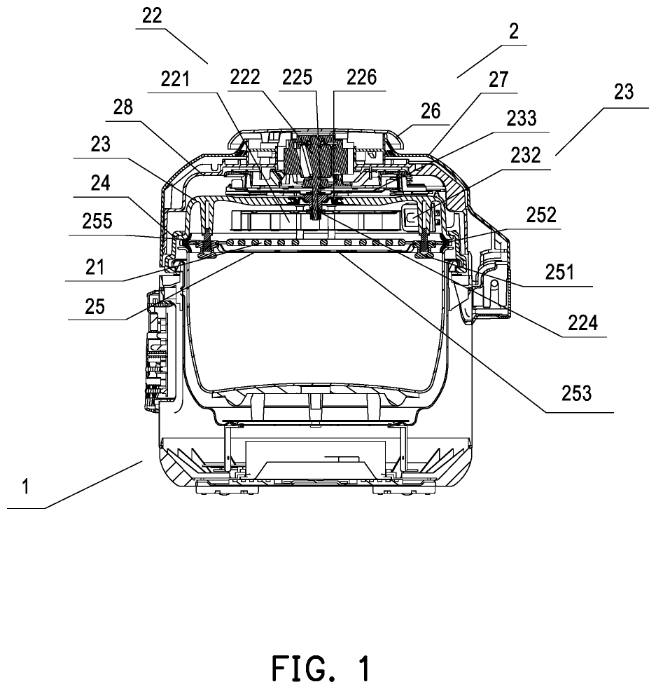

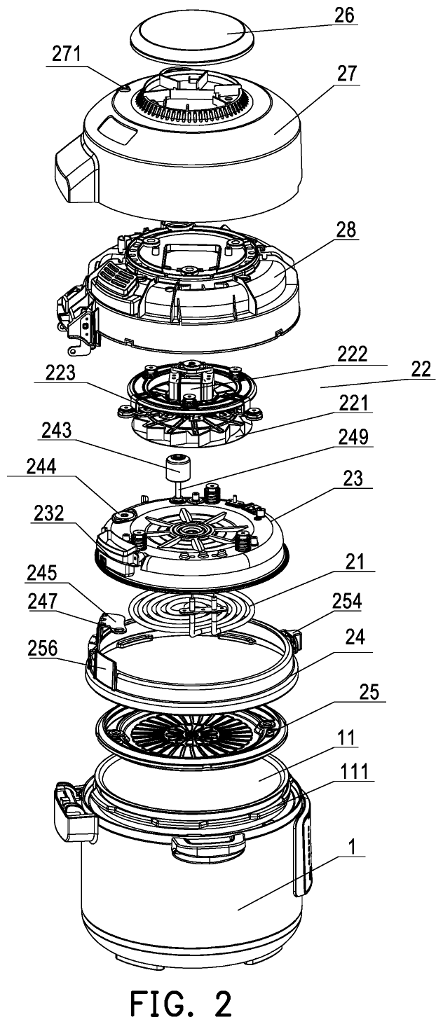

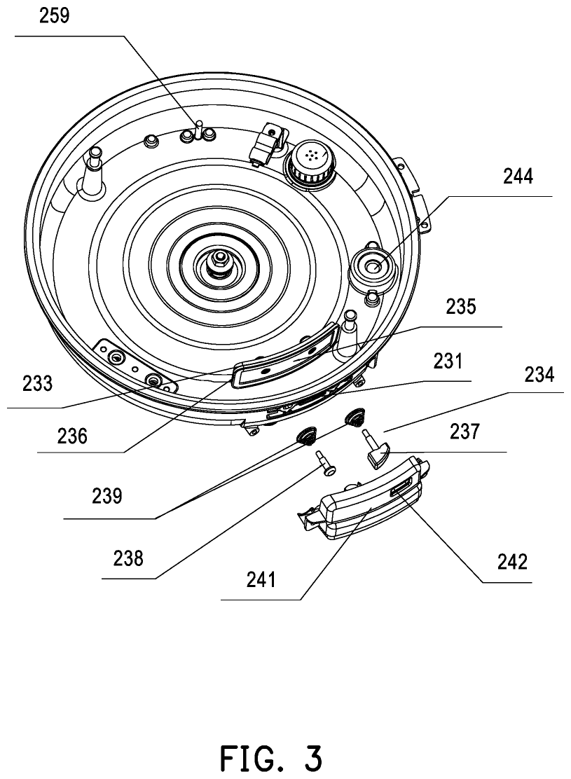

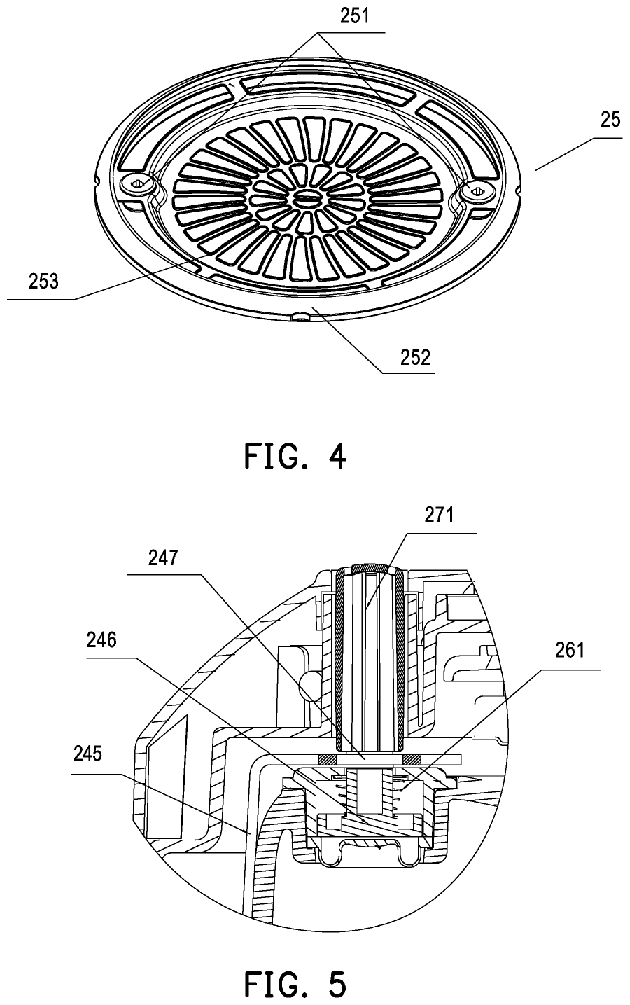

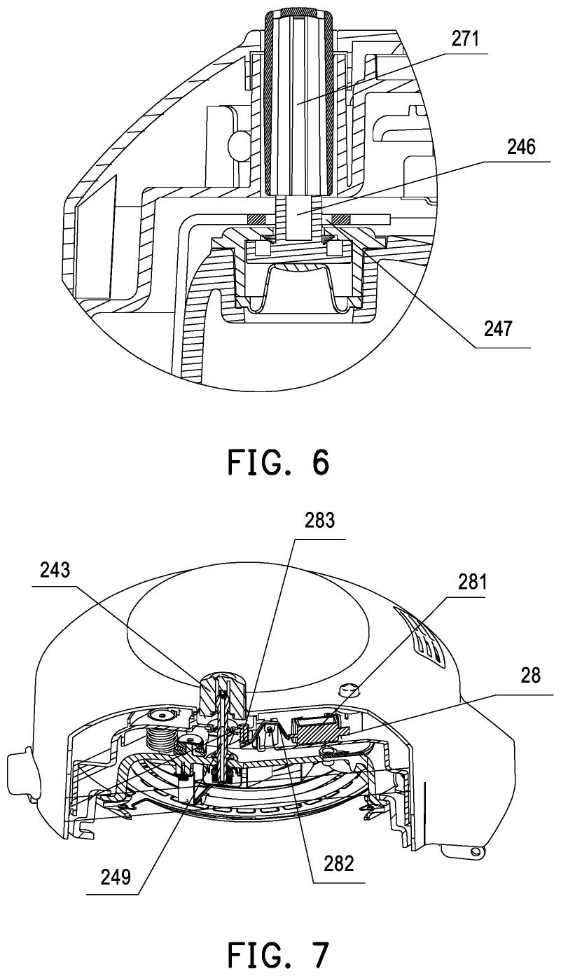

FIG. 1 to FIG. 13 show a first embodiment of a multifunctional cooker of the present invention. The multifunctional cooker comprises a pressure cooker body 1 and an upper cover assembly 2 covered on the pressure cooker body 1. The upper cover assembly 2 is provided with a heating assembly 21, a wind power assembly 22, and an inner top cover 23 that controls whether the upper cover assembly 2 is sealedly covered on the pressure cooker body 1. The wind power assembly 22 is provided with a main fan 221 for blowing hot air heated by the heating assembly 21 into the pressure cooker body 1 to cook, and the main fan 221 is provided above the inner top cover 23 and above the heating assembly 21.

The inner top cover 23 is provided with a first air inlet for air blown from the main fan 221 to flow in and a first air outlet for the hot air to flow out. The purpose of this configuration is to form hot air communication via the configuration of the first air inlet and the first air outlet of the main fan in the air fryer mode, so as to effectively perform the cooking of the air fryer. It should be noted that the first air inlet and the first air outlet may also be overlapped, as long as there is a complete air duct communication system inside to complete the air communication effect of the corresponding working mode.

It should be noted that the function of the inner top cover 23 is used to switch the internal sealing performance of the multifunctional cooker, thereby realizing the mutual switch between pressure cooking and air fryer functions, and realizing one cooker with multiple functions. The inner top cover 23 in present embodiment can be sealed or unsealed by controlling the first air inlet or the first air outlet. As for how to realize the control, it is mainly combined with a way of the control member in embodiment 2. Of course, in present embodiment, to control the first air inlet or the first air outlet is the preferable but not the only way, and other configurations are also permissible. For example, it is also feasible to configure a control port additionally. These can be configured according to actual needs.

In addition, the first air inlet is located at a top portion of the inner top cover 23, and the first air outlet is located on a side surface of the inner top cover 23, or the first air inlet is located at a central position of the top portion or the side surface of the inner top cover 23, and the first air outlet is located at a peripheral position of the top portion or the side surface of the inner top cover 23. It should be noted that the configuration of the positions of the first air inlet and the first air outlet are only preferred and not a restrictive provision, and the configuration of other positions is also feasible, as long as the communication of hot air can be smoothly realized.

The wind power assembly 22 further comprises a motor 222 for providing power and a cooling fan 223. The cooling fan 223 is used for sucking cold outside air for air ventilation so as to cool components in the upper cover assembly 2. The cooling fan 223 and the main fan 221 are sequentially connected to both ends of a sleeve 225 of an output shaft 224 of the motor 222. With such configuration, when in the air fryer cooking mode, the outside cold air can be sucked in by the cooling fan to lower the temperature of the surface of the motor and the inner top cover, avoiding the burning of the motor and damaging the inner top cover due to excessive temperature, and improving service life of the upper cover assembly. It should be noted that the heating assembly are generally provided under the inner top cover, and the heating assembly are preferably heating wires. Of course, these configurations are only preferred and not a restrictive provision.

### Embodiment 2

FIG. 1 to FIG. 13 show a second embodiment of a multifunctional cooker of the present invention. The multifunctional cooker comprises a pressure cooker body 1 and an upper cover assembly 2 covered on the pressure cooker body 1. The upper cover assembly 2 is provided with a heating assembly 21, a wind power assembly 22, and an inner top cover 23 that controls whether the upper cover assembly 2 is sealedly covered on the pressure cooker body 1. The wind power assembly 22 is provided with a main fan 221 for blowing hot air heated by the heating assembly 21 into the pressure cooker body 1 to cook, and the main fan 221 is provided below the inner top cover 23 and above the heating assembly 21.

The inner top cover 23 is provided with a first opening 231 for communicating with outside air and a control member 232 for controlling whether the first opening 231 is closed. The configuration of the first opening is, in the air fryer cooking mode, to facilitate the communication of air, and to also facilitate the water vapor generated after the food is heated to be discharged through the first opening, which is beneficial to produce a crisp effect on the food surface and improves the cooking effect. The configuration of the control member is to adapt to the two cooking modes by closing or opening the first opening. When in the pressure cooking mode, the first opening is closed. When in the air fryer mode (i.e., the baking and cooking mode), the first opening is opened.

The control member 232 comprises a movable valve assembly 233 for closing the first opening 231 and a drive assembly 234 for driving the movable valve assembly 233 to move so as to cover or open the first opening 231. The movable valve assembly 233 is located at a position of the first opening 231 at an inner side of the inner top cover 23. The drive assembly 234 passes through the first opening 231 and is connected with the movable valve assembly 233. Such configuration is to promote the movement of the movable valve assembly through the action of the drive assembly, thereby completing the closing or opening of the first opening, and realizing the closed or non-closed states of the upper cover assembly with the a space of the pressure cooker body to adapt to the needs of the pressure cooking mode (i.e., the pressure cooker mode) and the baking and cooking mode (i.e., the air fryer mode). Via the configuration that the movable valve assembly is located at a position of the first opening at an inner side of the inner top cover and that the drive assembly passes through the first opening and is connected with the movable valve assembly, the first opening may be opened by pushing the movable valve assembly forward and the movable valve assembly is covered at the position of the first opening to close first opening by pulling the movable valve assembly backward. Of course, it should be noted that this way of opening or closing the first opening is only preferred and is not a restrictive provision. Other similar structural designs are feasible as long as this effect can be realized. In addition, the inner top cover 23 is further provided with a valve hood 241, and the valve hood 241 is fixed on an outer side of the first opening 231. A bottom and two side surfaces of the valve hood 241 and a side surface of the inner top cover 23 are closed, and an upper opening of the valve hood 241 is connected to the outside. A side surface of the valve hood 241 has a through hole 242 inside which the drive rod 237 may stretch back and forth.

The movable valve assembly 233 comprises a valve body 235 and a valve sealing ring 236, and the valve sealing ring 236 is sleeved on the valve body 235. The drive assembly 234 comprises a drive rod 237 and a pull nail 238, and the drive rod 237 and the pull nail 238 movably pass through the first opening 231 and are both connected with the valve body 233. Such configuration is to provide a movable valve assembly for closing the first opening and a drive assembly for driving the movable valve assembly. It should be noted that this structure is only preferred and not a restrictive provision. The common configuration of the drive rod and the pull nail is to provide a balanced pulling force, so as to better realize the corresponding movement and avoid tilting.

Moreover, the upper cover assembly 2 is further provided with an inner buckle cover 24, and the inner buckle cover 24 is rotatably sleeved on an outer side of the inner top cover 23. The inner buckle cover 24 is provided with a baffle 256 for pushing the drive rod 237 to move so as to open the first opening 231, and a top portion of the drive rod 237 is an inclined portion. Return springs 239 are provided between the drive rod 236 and the position of the first opening 231, and are provided between the pull nail 237 and the position of the first opening 231, the return springs are used for pulling the drive rod 237 and the pull nail 238 to return so as to close the first opening 231. The configuration that the upper cover assembly is further provided with an inner buckle cover rotatably sleeved on the outer side of the inner top cover, and that the inner buckle cover is provided with a baffle for pushing the drive rod to move so as to open the first opening, and that the top portion of the drive rod is the inclined portion, provides a way to realize the relative position change of the inner buckle cover and the inner top cover by rotating the inner buckle cover. When the baffle touches the top portion of the drive rod, the baffle will push the drive rod to move, so as to push the movable valve assembly, i.e., the valve body and the valve sealing ring as a whole, to move, thereby opening the first opening. When no force is applied by the baffle, the return spring will provide restoring force, such that the drive rod and the pull nail move back together, thereby pulling the movable valve assembly to move and cover at a position of the first opening, thereby closing the first opening structure.

An isolation hood and a cooker cover sealing ring assembly 25 are provided below the inner top cover 23. The configuration of the isolation hood may prevent the pressure in the pressure cooker body from being directly applied to the motor in the pressure cooking mode, which reduces the bearing pressure problem of the motor shaft and increases the service life of the motor, and thus increases the service life of the upper cover assembly as a whole. At the same time, due to the configuration of the isolation hood, the problem of the gap between the motor shaft sleeve and the inner top cover may also be solved, thereby improving the sealing performance. Of course, such configuration mainly solves problem that the gap between the bearing and the bearing sleeve affects the pressure cooking of the multifunctional cooker when the main fan is located below the inner top cover. At the same time, it may also reduce the food pollution of the motor and other components during cooking, and may also improve the convenience of cleaning. In the present embodiment, for the convenience of cleaning, the isolation hood is detachably connected with the inner top cover 23. Of course, the isolation hood may also be fixedly connected with the inner top cover 23. The isolation hood is generally provided below the main fan and the heating assembly. Of course, the isolation hood may also be provided between the main fan and the heating assembly, and corresponding channels need to be provided in these different positions to facilitate the communication of hot air. This isolation hood is a conventional isolable structure, so it is not shown in the drawings.

In addition, the configuration of the cooker cover sealing ring assembly 25 functions to seal the inner pot in the pressure cooker body 1 and the inner top cover 23. It is generally provided at the position below the inner top cover 23 where the inner top cover 23 is covered and engaged with the inner pot of the pressure cooker body 1. The cooker cover sealing ring assembly 25 comprises a cooker cover sealing ring support 253 and a cooker cover sealing ring 252. The cooker cover sealing ring 252 is mounted on the cooker cover sealing ring support 253. In the present embodiment, in order to facilitate cleaning after used by the user, the sealing ring assembly is made to be detachable, and a handle 251 is provided on the cooker cover sealing ring support 253 for easy detachment. Two silicone handles 251 are fixed on the cooker cover sealing ring support 253, and the cooker cover sealing ring assembly 25 is pressed into a support rod 255 fixed on the inner top cover 23 by the handle 25 during use to conveniently complete the assembling. The configuration of the cooker cover sealing ring 252 is to realize the sealing after the upper cover assembly 2 is covered on the pressure cooker body 1.

In addition, the upper cover assembly 2 is further provided with a top cover 26, a face cover 27, and a middle cover 28 which are mounted in sequence. The wind power assembly 22 is mounted between the middle cover 28 and the inner top cover 23.

The heating assembly 21 is provided below the inner top cover 23. Generally, the heating assembly 21 is a heating tube or a heating wire. The heating assembly 21 is fixed in a cooking cavity at an inner side of the inner top cover 23 and functions to heat the air in the cavity.

In addition, a lower end of the motor shaft and the inner and outer sides of the inner top cover 23 are respectively connected with the main fan 221 and the cooling fan 223. The main fan 221 is located in the cooking cavity to accelerate the circulation of hot air in the cavity. The cooling fan 223 is located between the motor 222 and the inner top cover 23 and functions to suck the outside cold air to lower the temperature of the surfaces of the motor and the inner top cover. The shaft sleeve 225 is provided on the output shaft 224 of the motor. Both ends of the shaft sleeve 225 are respectively the main fan 221 and the cooling fan 223. The shaft sleeve 225 is dynamically connected with the inner top cover 23 by a shaft sleeve sealing ring 226. The shaft sleeve sealing ring 226 may seal the shaft sleeve when there is pressure in the cooker and may avoid being close tightly to the shaft sleeve of the motor when the motor rotates, and thus avoiding causing the motor to heat and burn.

The inner top cover 23 is the main pressure-bearing component, and the inner top cover is further provided with components such as a temperature sensor 259, an exhaust pipe 249, a pressure limiting valve 243, and a float valve assembly 244 and so on.

The pressure limiting valve 243 and the float valve assembly 244 are mainly components that work in the pressure cooking mode. The specific principle is as follows.

In the present embodiment, the middle cover 28 is mounted with an electromagnet 281. The pressure limiting valve 243 drives a lever 282 and a ejector rod 283 to move via the stretch and contraction of a electromagnet push rod, thereby realizing the sealing by the falling of the pressure limiting valve 243 and realizing the exhausting by the rising of the pressure limiting valve 243, and thus the maintenance and release of the pressure in the cooker is realized. The pressure-limiting valve 243 may also use common rotation and toggle to realize the purpose of sealing and exhausting.

In addition, the float valve assembly 244 is fixed on the inner top cover 23, and a float lock piece 245 is fixed on the inner buckle cover 24. In a closed state, a pressure-bearing float 246 in the float valve assembly 244 is located directly below a lock hole 247 in the float lock piece 245. When the pressure in the cooker is raised, the pressure-bearing float 246 rises, and a visible float 271 which is capable of moving up and down is raised to be higher than the face cover 27, indicating to the user that the pressure in the cooker has been raised. When the pressure in the cooker has not fallen below a safety pressure, the pressure-bearing float 246 is always located in the middle of the lock hole 247. At this time, the inner buckle cover 24 cannot be rotated to open, which may prevent the user from opening the cooker cover by mistake and causing danger. Of course, a second return spring 261 for return is further provided.

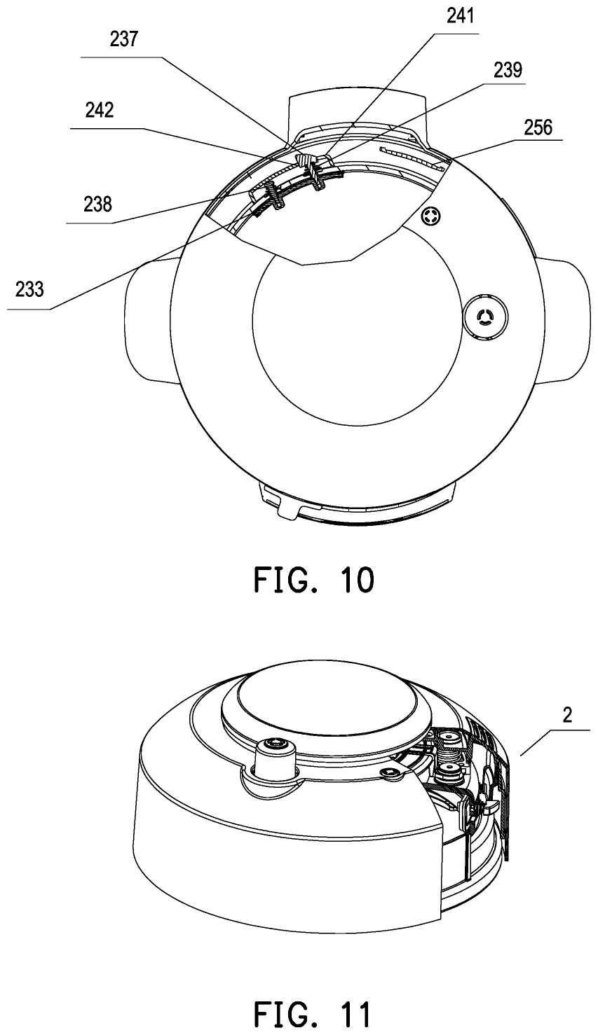

The specific cooking working principle is as follows. As shown in FIG. 10 and FIG. 11, when the inner buckle cover 24 is rotated to the closed state, the drive rod and the pull nail pull the valve body outward under the force of the return spring, and the valve seal ring closes the first opening 231. At this time, the pressure in the multifunctional cooker can be smoothly raised for pressure cooking.

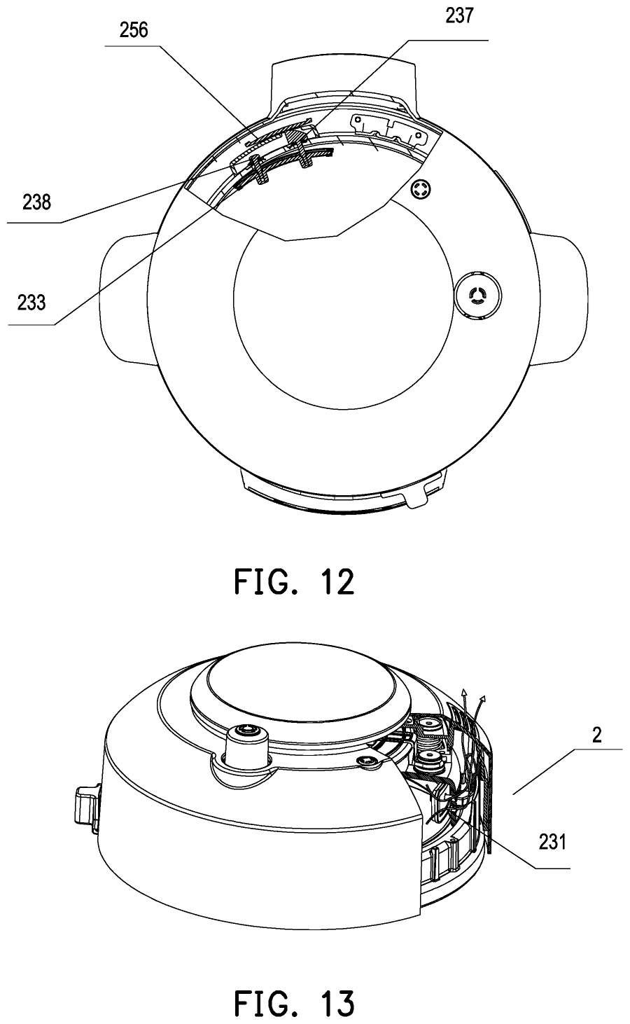

As shown in FIG. 12 and FIG. 13, when the inner buckle cover 24 is rotated to the opened state, the baffle 256 on the inner buckle cover rotates to a position of the drive rod, and the drive rod is pressed into the valve hood. And thus the valve body is pushed open, and the air in cooker is communicated to the atmosphere, and the cooker can be used as an air fryer for cooking at this time. The water vapor generated after the food is heated may be discharged to the outside of the product through the first opening 231, which is beneficial to produce a crisp effect on the surface of the food. The arrow shown in FIG. 13 indicates that the water vapor in the cooker is discharged outside from the product through the first opening 231.

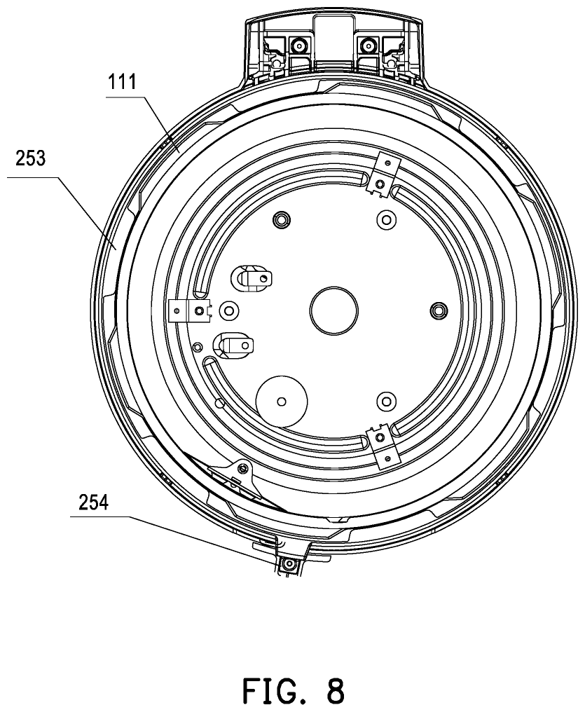

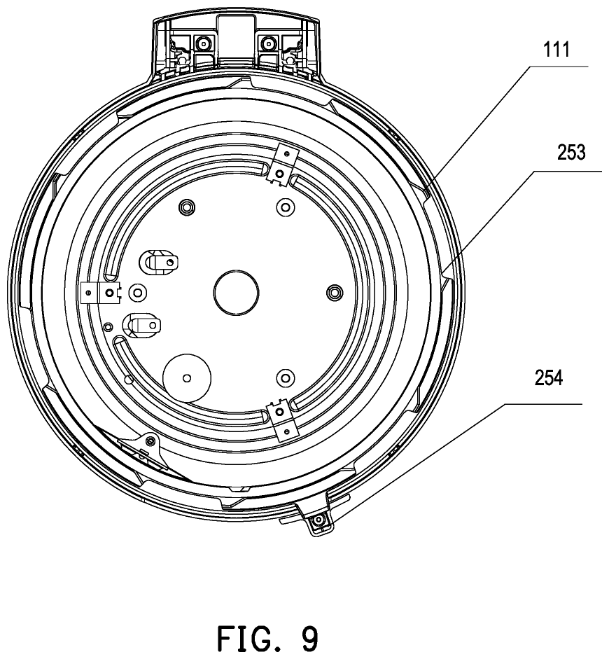

In addition, the inner buckle cover 24 is sleeved on the outer periphery of the inner top cover 23, with a plurality of buckle teeth 253 below, and with a dial button 254, which can be operated by the user to rotate the inner buckle cover 24. When using the air fryer function, the inner buckle cover 24 is rotated counterclockwise by the user such that the buckle teeth 253 are staggered from heat preservation cover buckle teeth 111 of the heat preservation cover 11 on the pressure cooker body 1 (i.e., the opened state, as shown in FIG. 8). When using the pressure cooker function, the inner buckle cover 24 is rotated clockwise by the user to make the buckle teeth 253 overlap the heat preservation cover buckle teeth 111 (i.e., the closed state, as shown in FIG. 9).

Obviously, the above-mentioned embodiments of the present invention are merely examples for clearly illustrating the present invention, rather than limiting the embodiments of the present invention. For those skilled in the art, other different forms of changes or variations can be made based on the above description. There is no need to exhaustively list all implementations. Any modification, equivalent replacement and improvement made within the spirit and principle of the present invention should be included in the protection scope of the claims of the present invention.

1. A multifunctional cooker, comprising a pressure cooker body and an upper cover assembly covered on the pressure cooker body, wherein the upper cover assembly is provided with a heating assembly, a wind power assembly, and an inner top cover that controls whether the upper cover assembly is sealedly covered on the pressure cooker body, the wind power assembly is provided with a main fan for blowing hot air heated by the heating assembly into the pressure cooker body to cook, and the main fan is provided above the inner top cover and above the heating assembly.

2. The multifunctional cooker according to claim 1, wherein the inner top cover is provided with a first air inlet for air blown from the main fan to flow in and a first air outlet for the hot air to flow out.

3. The multifunctional cooker according to claim 2, wherein the first air inlet is located at a top portion of the inner top cover, and the first air outlet is located on a side surface of the inner top cover; or the first air inlet is located at a central position of the top portion or the side surface of the inner top cover, and the first air outlet is located at a peripheral position of the top portion or the side surface of the inner top cover.

4. The multifunctional cooker according to claim 2, wherein the wind power assembly further comprises a motor for providing power and a cooling fan for sucking cold outside air for air ventilation so as to cool components in the upper cover assembly, the cooling fan and the main fan are sequentially connected to two ends of a sleeve of an output shaft of the motor.

5. A multifunctional cooker, comprising a pressure cooker body and an upper cover assembly covered on the pressure cooker body, wherein the upper cover assembly is provided with a heating assembly, a wind power assembly, and an inner top cover that controls whether the upper cover assembly is sealedly covered on the pressure cooker body, the wind power assembly is provided with a main fan for blowing hot air heated by the heating assembly into the pressure cooker body to cook, and the main fan is provided below the inner top cover and above the wind power assembly.

6. The multifunctional cooker according to claim 5, wherein the inner top cover is provided with a first opening for communicating with outside air and a control member for controlling whether the first opening is closed.

7. The multifunctional cooker according to claim 6, wherein the control member comprises a movable valve assembly for closing the first opening and a drive assembly for driving the movable valve assembly to move so as to cover or open the first opening, the movable valve assembly is located at a position of the first opening at an inner side of the inner top cover, the drive assembly passes through the first opening and is connected with the movable valve assembly.

8. The multifunctional cooker according to claim 7, wherein the movable valve assembly comprises a valve body and a valve sealing ring, the valve sealing ring is sleeved on the valve body, the drive assembly comprises a drive rod and a pull nail, and the drive rod and the pull nail movably passes through the first opening and are both connected with the valve body.

9. The multifunctional cooker according to claim 8, wherein the upper cover assembly is further provided with an inner buckle cover, the inner buckle cover is rotatably sleeved on an outer side of the inner top cover, the inner buckle cover is provided with a baffle for pushing the drive rod to move so as to open the first opening, and a top portion of the drive rod is an inclined portion; return springs are provided between the drive rod and the position of the first opening, and are provided between the pull nail and the position of the first opening, the return springs are configured for pulling the drive rod and the pull nail to return so as to close the first opening.

10. The multifunctional cooker according to claim 5, wherein an isolation hood and a cooker cover sealing ring assembly are provided below the inner top cover.

11. The multifunctional cooker according to claim 3, wherein the wind power assembly further comprises a motor for providing power and a cooling fan for sucking cold outside air for air ventilation so as to cool components in the upper cover assembly, the cooling fan and the main fan are sequentially connected to two ends of a sleeve of an output shaft of the motor.

12. The multifunctional cooker according to claim 6, wherein an isolation hood and a cooker cover sealing ring assembly are provided below the inner top cover.

13. The multifunctional cooker according to claim 7, wherein an isolation hood and a cooker cover sealing ring assembly are provided below the inner top cover.

14. The multifunctional cooker according to claim 8, wherein an isolation hood and a cooker cover sealing ring assembly are provided below the inner top cover.

15. The multifunctional cooker according to claim 9, wherein an isolation hood and a cooker cover sealing ring assembly are provided below the inner top cover.
